(19) United States
(12) Patent Application Publication
(10) Pub. No.: US 2010/0147814 A1
(43) Pub. Date: Jun. 17, 2010

(54) METHOD OF CUTTING PLASTIC SUBSTRATE AND APPARATUS FOR CUTTING PLASTIC SUBSTRATE

(75) Inventor: Noriko Watanabe, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/518,453

(22) PCT Filed: Oct. 29, 2007
(86) PCT No.: PCT/JP2007/071050

§ 371 Date: Jun. 10, 2009

(30) Foreign Application Priority Data
Mar. 16, 2007 (JP) 2007-068544

(51) Int. Cl. B23K 26/16; B23K 26/38; B23K 26/42

(52) U.S. Cl. 219/121.72; 219/121.78; 219/121.84; 219/121.85

(57) ABSTRACT

A laser emitter arranged to face a plastic substrate makes relative movement along a surface of the plastic substrate, while it is emitting a laser, so as to laser-cut the plastic substrate. In this process, a shield member is arranged outside a laser irradiation region on the plastic substrate.

### BACKGROUND OF THE INVENTION

1. Field of the Invention

The present invention relates to a method for cutting a plastic substrate and an apparatus for cutting a plastic substrate.

2. Description of the Related Art

In recent years, active research on displays, such as liquid crystal displays, organic EL devices, etc., has been conducted. In the display of this kind, a glass substrate is often used for supporting a display medium layer and the like. However, use of a flexible plastic substrate has been considered for the purpose of giving flexibility to the display itself, and reducing the thickness of the display while maintaining the strength of the substrate.

For example, in the manufacture of a liquid crystal display device including a plastic substrate, TFTs, a transparent electrode, and the like are formed on one plastic substrate base, and a color filter, a transparent electrode, and the like are formed on another plastic substrate base. Then, alignment films are formed to cover the transparent electrodes, respectively, and the alignment films are rubbed to provide orientation. Then, a sealant resin is applied to one of the plastic substrate bases, and the plastic substrate bases are bonded to each other. Then, the sealant resin is cured. The bonded substrate bases are cut into liquid crystal cells. This cutting process may also be called an outline cutting process. Subsequently, liquid crystal is injected into the liquid crystal cells, and injection ports through which the liquid crystal is injected are sealed.

As a result, a liquid crystal display device including a TFT substrate on which the TFTs are formed, a CF substrate on which the color filter is formed, and a liquid crystal layer sealed between the substrates by a sealant is manufactured.

In the above-described manufacture, a process of cutting the substrate is significantly different from the manufacture using a glass substrate base. In the process of cutting the substrate, the CF substrate may be cut at a position facing a terminal region of the TFT substrate provided with a plurality of terminals (i.e., a single substrate is cut) so that the terminal region is exposed, or the substrates may be cut along the outlines of the liquid crystal cells (i.e., two bonded substrates are cut together).

In general, in cutting the glass substrate, a so-called scribe-break method is used. Specifically, a scar (a scribe groove) is formed on the surface of the glass substrate, and then impact is applied to the glass substrate. This allows the scar to grow into a crack, and the glass substrate is cut.

Although the plastic substrate cannot be cut by the scribe-break method, it can be cut by various methods, such as laser cutting, dicing, and stamping.

However, the dicing takes a long time to cut the substrate, and therefore, it is not suitable for cutting the substrate into a plurality of liquid crystal cells. In addition, the dicing with simultaneous water cooling is not suitable for cutting at a region near the injection port.

In stamping the substrate, a large amount of powder-like chippings, which are flakes of the substrate, is dispersed, and a cutting tool may easily deteriorate depending on the material of the substrate. Therefore, the laser cutting is relatively suitable for cutting the plastic substrate.

In the laser cutting, however, a region near a cut section may be sooted or discolored due to smoke and heat generated in the cutting process. As a solution to this problem, there is a known technique of forming a protection film on the surface of the substrate base by spraying a thermosetting resin (e.g., see Published Japanese Patent Application No. S59-151130). The protection film is formed to prevent the contamination of the substrate base.

According to the method of Published Japanese Patent Application No. S59-151130, the resin is sprayed, and the sprayed resin may be dispersed to become another cause of the contamination of the substrate. Therefore, in particular, this process cannot be used to cut the substrate before bonding. In spraying the resin to the bonded substrates, the sprayed resin inevitably enters a gap between the bonded substrates at side ends of the substrates, and the resin adheres thereto to become a contaminant. Further, when the resin is not uniformly adhered onto the surface of the substrate, the resulting protection film may have surface irregularity, and therefore, an optical characteristic of the substrate may deteriorate. This will cause a particularly significant problem when the substrate is applied to a display. Further, in bonding a polarizer to the substrate, the irregularity of the protection film may deteriorate the adhesion between the polarizer and the substrate.

### SUMMARY OF THE INVENTION

The inventor of the present application conducted various research on the laser cutting of the plastic substrate, and made the following findings and discoveries.

As the plastic substrate, generally used are a resin substrate made of PES (polyether sulfone), PET (polyethylene terephthalate), PEN (polyethylene naphthalate), or the like, and a composite substrate made of a composition of carbon or glass fiber, a fabric cloth, and a resin.

When the plastic substrate is laser-cut using a shorter wavelength laser, the substrate may cause a decomposition reaction. Further, when a longer wavelength laser is used, the substrate may experience transpiration due to heat of the laser, or the substrate may be broken by thermal shock.

Portions of the chippings of the substrate and the gas dispersed in the air are bounced back from a laser apparatus and adhere to a front surface of the substrate near the cut section, and the other portion adheres to a rear surface of the substrate. The adherents are hard to remove by easy cleaning, such as dipping into water or a solvent, shower cleaning, ultrasonic cleaning, and the like.

In recent years, a frame of the display device is becoming narrower, and therefore, a distance between a cutting line and an effective display region or terminals becomes smaller in many cases. For this reason, it is more likely that the adherents bring about problems, such as failure in display, and failure in connection with the terminals.

As shown in a cross-sectional view of FIG. 15, in cutting the two bonded plastic substrates 101 and 102 simultaneously, the level of the contamination increases, and the above-described problems become noticeable. This may be derived from chippings of the substrate 101 and gas 105 that enter a gap 103 of about 5 μm to about 10 μm between the two plastic substrates 101 and 102 when the upper substrate 101 is cut by a laser emitted from an emitter 104.

In view of the foregoing, preferred embodiments of the present invention prevent contamination near a laser-cut section of a plastic substrate, while maintaining an optical characteristic of the plastic substrate.

According to a preferred embodiment of the present invention, a method for laser-cutting a plastic substrate includes making relative movement of a laser emitter along a surface of the plastic substrate, with the laser emitter emitting a laser, wherein a shield member is arranged outside a laser irradiation region on the plastic substrate.

The shield member is preferably arranged on at least one of a side of the plastic substrate facing the emitter and a side of the plastic substrate opposite the emitter.

The shield member may be in the shape of a tube surrounding at least a portion of the emitter.

Another preferred embodiment of the present invention provides a method for laser-cutting a plastic substrate by making relative movement of a laser emitter along a surface of the plastic substrate, with the laser emitter emitting a laser, wherein an exhaust port of an exhaust system is arranged to face a laser irradiation region on the plastic substrate.

The exhaust port is preferably arranged on at least one of a side of the plastic substrate facing the emitter and a side of the plastic substrate opposite the emitter.

Another method of cutting a plastic substrate according to a preferred embodiment of the present invention is a method for laser-cutting a plastic substrate including making relative movement of a laser emitter along a surface of the plastic substrate, with the laser emitter emitting a laser, wherein irradiation with the laser is performed with a surface of the plastic substrate opposite the emitter being in contact with liquid.

The liquid preferably flows along the surface of the plastic substrate.

The plastic substrate may include a pair of substrates bonded together with a sealant, and the plastic substrate may be cut at a region where the sealant is arranged.

A preferred embodiment of the present invention provides an apparatus for cutting a plastic substrate including: a stage on which the plastic substrate is placed; and a laser emitter arranged to face the stage, with the emitter emitting a laser and making relative movement along a surface of the plastic substrate to laser-cut the plastic substrate, wherein the apparatus includes a shield member arranged outside a laser irradiation region on the plastic substrate.

The shield member may be fixed to the emitter.

The shield member may be in the shape of a tube surrounding at least a portion of the laser emitter.

The shield member may be fixed to the stage on a side of the plastic substrate opposite the emitter.

The shield member may include a mask member placed on the plastic substrate and has a slit penetrating the mask member and extending in a direction in which the plastic substrate is cut, and a shield plate formed on the mask member to extend along the slit.

Another preferred embodiment of the present invention provides another apparatus for cutting a plastic substrate including: a stage on which the plastic substrate is placed; and a laser emitter arranged to face the stage, with the emitter emitting a laser and making relative movement along a surface of the plastic substrate to laser-cut the plastic substrate, wherein the apparatus includes an exhaust system having an exhaust port arranged to face a laser irradiation region on the plastic substrate.

The exhaust port may be arranged on at least one of a side of the plastic substrate facing the emitter and a side of the plastic substrate opposite the emitter.

Another preferred embodiment of the present invention provides another apparatus for cutting a plastic substrate including: a stage on which the plastic substrate is placed; and a laser emitter arranged to face the stage, with the emitter emitting a laser and making relative movement along a surface of the plastic substrate to laser-cut the plastic substrate, wherein the apparatus includes a storage tank containing liquid so that the liquid is in contact with a surface of the plastic substrate opposite the emitter.

In cutting the plastic substrate by the above-described cutting method, the laser emitter arranged to face the plastic substrate is allowed to make relative movement along the surface of the plastic substrate, with the laser emitter emitting the laser. On a region of the plastic substrate irradiated with the laser, the plastic substrate is cut by the applied laser. In this process, chippings of the substrate and gas (hereinafter referred to as contaminants) are generated near the irradiated region.

In a preferred embodiment of the present invention, the shield member is arranged outside the laser irradiation region on the plastic substrate. Therefore, the contaminants can be blocked by the shield member. Specifically, adhesion of the contaminants to the plastic substrate can be prevented, and therefore, contamination of a region near the cut section can be prevented. Further, since there is no need to form a protection film on the plastic substrate in preferred embodiments of the present invention, an optical characteristic of the plastic substrate does not deteriorate.

When the shield member is arranged on the side of the plastic substrate facing the laser emitter, the contaminants generated on the side facing the emitter are blocked by the shield member. This arrangement makes it possible to prevent contamination of the surface of the plastic substrate facing the emitter. On the other hand, when the shield member is arranged on the side of the plastic substrate opposite the laser emitter, the contaminants generated on the side opposite the emitter are blocked by the shield member. This arrangement makes it possible to prevent the contamination of the surface of the plastic substrate opposite the emitter.

The shield member preferably formed in the shape of a tube surrounding at least portion of the laser emitter can block the contaminants while it moves relative to the plastic substrate together with the emitter. Specifically, irrespective of the shape which the plastic substrate is cut into, the generated contaminants can be blocked by the shield member.

The exhaust port of the exhaust system can be arranged to face the laser irradiation region on the plastic substrate. When the plastic substrate is laser-cut in this state, the contaminants generated by the cutting is eliminated by the exhaust system through the exhaust port. This makes it possible to prevent the contamination of the plastic substrate by the contaminants.

When the exhaust port is arranged on the side of the plastic substrate facing the emitter, the contaminants generated on the side of the emitter are eliminated through the exhaust port. On the other hand, when the exhaust port is arranged on the side of the plastic substrate opposite the emitter, the contaminants generated on the side opposite the emitter are eliminated through the exhaust port.

When the plastic substrate is laser-cut with the side thereof opposite the emitter being in contact with liquid, the contaminants generated on the side of the plastic substrate opposite the emitter are dispersed into the liquid. This structure makes it possible to prevent re-adhesion of the contaminants to the surface of the plastic substrate. In particular, when the liquid flows along the surface of the plastic substrate, the dispersion of the contaminants to the liquid is promoted, and the re-adhesion of the contaminants can be prevented with more efficiency.

When the plastic substrate is used to form a display panel such as a liquid crystal display panel or the like, the plastic substrate includes a pair of substrates bonded together with a sealant. In this case, when the plastic substrate is cut at a region where the sealant is arranged, the contaminants generated by the cutting do not enter a gap between the paired substrates because the sealant fills the gap between the paired substrates in the cut region. This structure makes it possible to prevent contamination of the plastic substrate.

In cutting the plastic substrate using the apparatus for cutting the plastic substrate of the present invention, the emitter is allowed to make relative movement along the surface of the plastic substrate placed on the stage. In this manner, the plastic substrate is cut by the above-described method.

The fixing of the shield member to the emitter allows the shield member to make relative movement together with the emitter. On the other hand, fixing the shield member to the stage on the side of the plastic substrate opposite the emitter (i.e., on the side of the stage) makes it possible to prevent the contamination of the plastic substrate on the side facing the stage. The shield member may include a mask member having a slit penetrating the mask member and extending in a direction in which the plastic substrate is cut, and a shield plate extending along the slit. In this case, the emitter makes relative movement along the slit to form a cutting line along the slit. The contaminants generated by the cutting are blocked by the shield plate.

When the apparatus for cutting the plastic substrate includes an exhaust system, and the exhaust system has an exhaust port arranged to face the laser irradiation region on the plastic substrate, the contaminants generated by the laser cutting are eliminated by the exhaust system through the exhaust port.

When a storage tank containing liquid is arranged on the side of the plastic substrate opposite the emitter, and the liquid in the storage tank is brought into contact with the surface of the plastic substrate, the contaminants can be dispersed in the liquid as described above, and therefore, the contamination of the plastic substrate is prevented.

According to a preferred embodiment of the present invention, the shield member is arranged outside the laser irradiation region on the plastic substrate, and the shield member thus arranged can block the contaminants such as chippings of the substrate and gas generated by the cutting of the plastic substrate. This structure can prevent the adhesion of the contaminants to the plastic substrate, and can prevent the contamination of the substrate near the cut section. Further, according to a preferred embodiment of the present invention, there is no need to form a protection film on the plastic substrate. Therefore, a good optical characteristic of the plastic substrate can be maintained.

With the exhaust port of the exhaust system arranged to face the laser irradiation region on the plastic substrate, the contaminants generated by the cutting can be eliminated by the exhaust system through the exhaust port. This structure makes it possible to prevent the contamination of the plastic substrate by the contaminants.

Further, by irradiating the plastic substrate with the laser while the surface of the plastic substrate opposite the emitter is in contact with liquid, the contaminants generated on the side of the plastic substrate opposite the emitter can be dispersed into the liquid. This structure makes it possible to prevent the re-adhesion of the contaminants to the surface of the plastic substrate.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view illustrating an enlargement of a major portion of a cutting apparatus according to Preferred Embodiment 1 of the present invention.

FIG. 2 is a cross-sectional view illustrating a plastic substrate being cut.

FIG. 3 is a plan view illustrating an enlargement of a major portion of the cutting apparatus.

FIG. 4 is a cross-sectional view illustrating the structure of a shield member of Preferred Embodiment 2 of the present invention.

FIG. 5 is a perspective view illustrating the appearance of the shield member of Preferred Embodiment 2 of the present invention.

FIG. 6 is a cross-sectional view schematically illustrating an exhaust port of an exhaust system of Preferred Embodiment 3 of the present invention.

FIG. 7 is a cross-sectional view illustrating an exhaust system and a shield member of Preferred Embodiment 4 of the present invention.

FIG. 8 is a cross-sectional view schematically illustrating the structure of a shield member of Preferred Embodiment 5 of the present invention.

FIG. 9 is a cross-sectional view illustrating a plastic substrate being cut.

FIG. 10 is a cross-sectional view illustrating a plastic substrate placed on a storage tank of Preferred Embodiment 6 of the present invention.

FIG. 11 is a cross-sectional view illustrating a plastic substrate being cut.

FIG. 12 is a cross-sectional view illustrating a storage tank in which water flows.

FIG. 13 is a cross-sectional view schematically illustrating part of a plastic substrate of Preferred Embodiment 7, which is a bonded substrate.

FIG. 14 is a cross-sectional view illustrating a plastic substrate being cut.

FIG. 15 is a cross-sectional view illustrating a plastic substrate being laser-cut by a conventional method.

### DETAILED DESCRIPTION OF THE PREFERRED EMBODIMENTS

Hereinafter, preferred embodiments of the present invention will be described in detail with reference to the drawings. It should be noted that the present invention is not limited to the following preferred embodiments.

### Preferred Embodiment 1

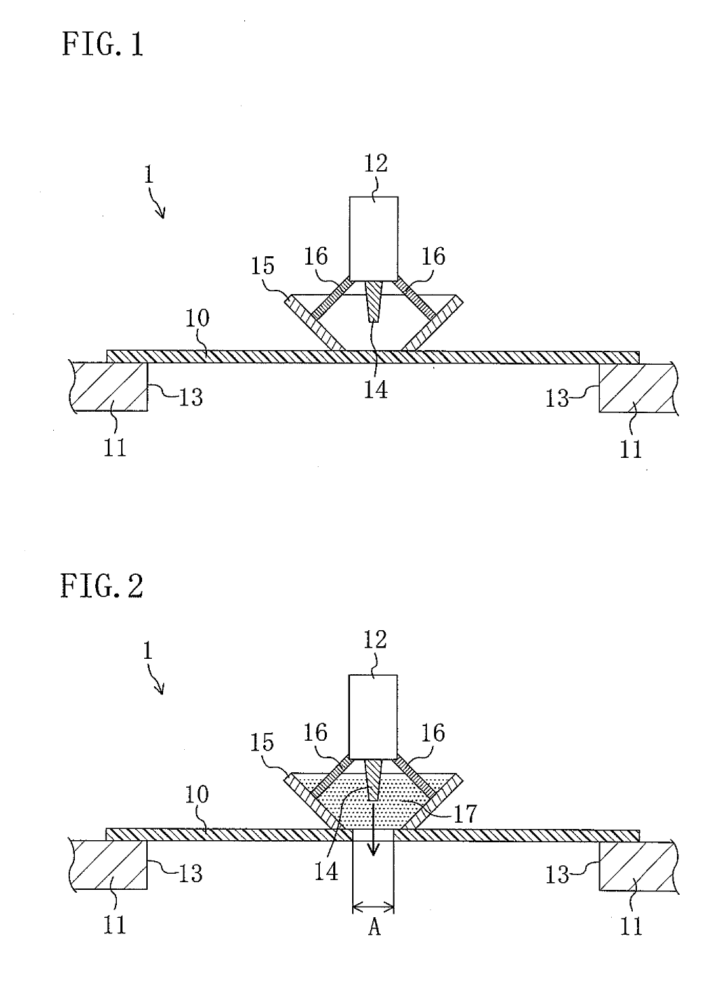

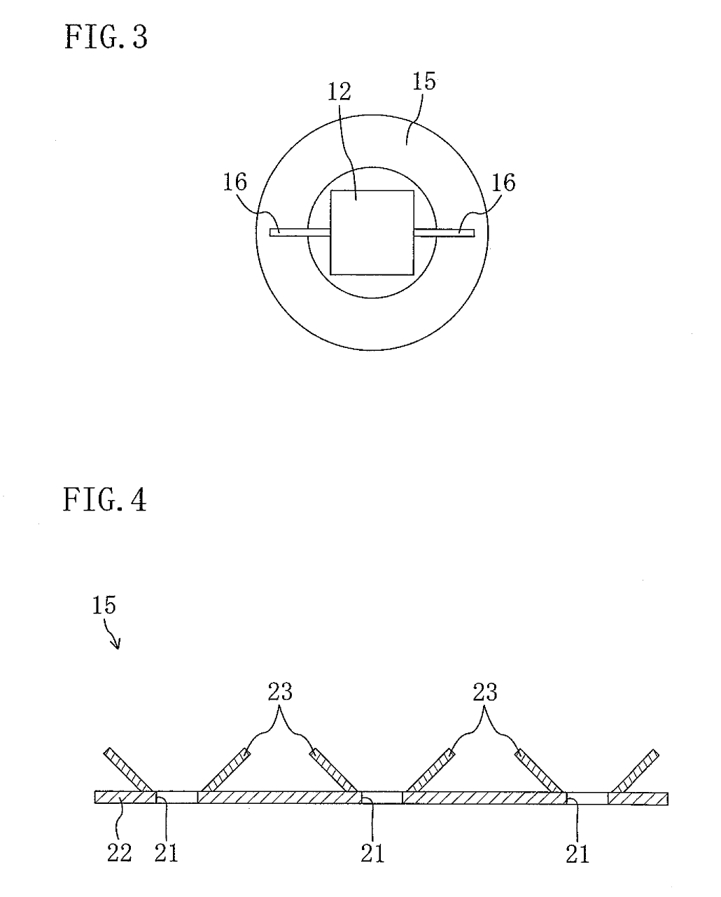

FIGS. 1 to 3 illustrate Preferred Embodiment 1 of the present invention. FIG. 1 is a cross-sectional view illustrating an enlargement of a major portion of a cutting apparatus 1 for cutting a plastic substrate 10, FIG. 2 is a cross-sectional view illustrating the plastic substrate 10 being cut, and FIG. 3 is a plan view illustrating an enlargement of a major portion of the cutting apparatus 1.

The cutting apparatus 1 for cutting the plastic substrate 10 according to Preferred Embodiment 1 includes a stage 11 on which the plastic substrate 10 is placed, and a laser emitter 12 arranged to face the stage 11. The emitter 12 is allowed to make relative movement along a surface of the plastic substrate 10 while emitting a laser, so as to laser-cut the plastic substrate 10.

Specifically, as shown in FIG. 1, the stage 11 is in the shape of, for example, a flat plate arranged to extend horizontally. The stage 11 includes an opening 13 which is opened at least in a region of the stage 11 facing a region of the plastic substrate 10 in which the laser cutting is performed.

When the stage 11 is arranged near a laser irradiation region A on the plastic substrate 10, heat generated by the laser cutting is transmitted to and stored in the stage 11. This results in large heat damage to the plastic substrate 10. However, the provision of the opening 13 according to Preferred Embodiment 1, the heat damage can be reduced. From this point of view, it is preferable to form a relatively large opening as the opening 13.

The emitter 12, which faces the plastic substrate 10 and the stage 11, is capable of moving parallel or substantially parallel to the plastic substrate 10 and the stage 11. The emitter 12 is configured to emit a laser from a bottom end 14 as shown in FIG. 2.

The plastic substrate 10 may be made of, for example, an about 200 μm thick PES film. The plastic substrate 10 after the cutting may constitute, for example, a liquid crystal display panel of a liquid crystal display. The emitter 12 preferably emits a 30 W CO₂ laser beam while moving at a rate of 30 mm/sec, for example.

According to a preferred embodiment of the present invention, the cutting apparatus 1 includes, for example, as shown in FIG. 2, a shield member 15 which is arranged outside the laser irradiation region A on the plastic substrate 10. The shield member 15 blocks contaminants 17 such as chippings of the substrate, gas and the like that are generated from the irradiation region A in the laser cutting process.

As shown in FIGS. 1 to 3, the shield member 15 is in the shape of a tube surrounding at least part of the emitter 12, and has a tapered cross section with its inner diameter increasing from a bottom end to a top end. In other words, an inner diameter of the top of the opening of the shield member 15 is larger than that of the bottom of the opening. The inner diameter of the bottom of the opening is larger than the laser irradiation region A.

The shield member 15 is fixed to the emitter 12 by a bracket 16. Specifically, the shield member 15 is arranged on the side of the plastic substrate 10 facing the emitter 12. An end of the bracket 16 is fixed to an inner wall surface of the shield member 15, and the other end of the bracket 16 is fixed to the emitter 12. The shield member 15 is preferably detachable from the emitter 12 so that the shield member 15, if contaminated, can be replaced with a new shield member.

The shield member 15 is held onto the emitter 12 so that a bottom end thereof is in close contact with the surface of the plastic substrate 10. The end of the shield member 15 is preferably machined to reduce friction, so that the shield member 15 does not generate scars on the surface of the plastic substrate 10 even when the shield member 15 rubs the surface of the plastic substrate 10.

On the plastic substrate 10, a plurality of alignment marks (not shown) are formed. The cutting apparatus 1 includes a cutting position adjuster (not shown) which detects the alignment marks and adjusts a cutting position on the plastic substrate 10 (i.e., a position of the laser irradiation region A). The cutting apparatus 1 further includes a height adjuster (not shown) which keeps a certain distance from the emitter 12 and the shield member 15 to the surface of the plastic substrate 10. The height adjuster is configured to detect a distance from the emitter 12 and the shield member 15 to the plastic substrate 10, and to bring the bottom end of the shield member 15 to be in close contact with the surface of the plastic substrate 10.

### Method for Cutting the Plastic Substrate

Now, a method for cutting the plastic substrate 10 using the cutting apparatus 1 will be described below. According to the cutting method of Preferred Embodiment 1, the laser emitter 12 which is arranged to face the plastic substrate 10 is allowed to make relative movement along the surface of the plastic substrate 10 while emitting a laser so as to laser-cut the plastic substrate 10.

First, the plastic substrate 10 is placed on and fixed to a predetermined position on the top surface of the stage 11. The position of the plastic substrate 10 relative to the stage 11 is adequately determined by the alignment marks formed on the plastic substrate 10.

Then, as shown in FIG. 1, the emitter 12 to which the shield member 15 is fixed is arranged at a predetermined position to face the plastic substrate 10. The position of the emitter 12 and the shield member 15 relative to the plastic substrate 10 is determined by the cutting position adjuster which is not shown. Thus, the shield member 15 is arranged outside the laser irradiation region A on the side of the plastic substrate 10 facing the emitter 12.

Then, as shown in FIG. 2, the emitter 12 which is emitting a laser is moved along a cutting line on the plastic substrate 10 together with the shield member 15. As a result, the plastic substrate 10 is cut at the region A irradiated with the laser relatively moving along the cutting line.

### Effects of Preferred Embodiment 1

In a portion of the plastic substrate 10 near the laser irradiation region A, as shown in FIG. 2, contaminants 17, such as chippings of the plastic substrate 10 and gas, are generated in the cutting process of the plastic substrate 10. According to Preferred Embodiment 1, however, the shield member 15 is arranged outside the laser irradiation region A on the plastic substrate 10. Therefore, the shield member 15 can block the contaminants 17 generated on the surface of the plastic substrate 10 facing the emitter 12. Specifically, the contaminants 17 generated in the irradiation region A are blocked because they adhere to the inner wall surface of the shield member 15.

Particularly in Preferred Embodiment 1, the shield member 15 is in the shape of a tapered tube surrounding portion of the emitter 12. Therefore, the shield member 15 of such a shape can enclose the irradiation area A, and can prevent the dispersion of the contaminants 17 generated in the irradiation region A into the surrounding environment. This structure makes it possible to prevent the adhesion of the contaminants 17 to the plastic substrate 10, and to prevent the contamination of a portion of the substrate around the cut section.

Since the tubular shield member 15 is fixed to the emitter 12, the shield member 15 can make relative movement together with the emitter 12. That is, irrespective of the shape of the cutting line, the contaminants 17 can be blocked.

In addition, according to Preferred Embodiment 1, there is no need to form a protection film or the like on the plastic substrate 10 to prevent the contamination of the plastic substrate 10. This makes it possible to maintain a good optical characteristic of the plastic substrate 10.

### Preferred Embodiment 2

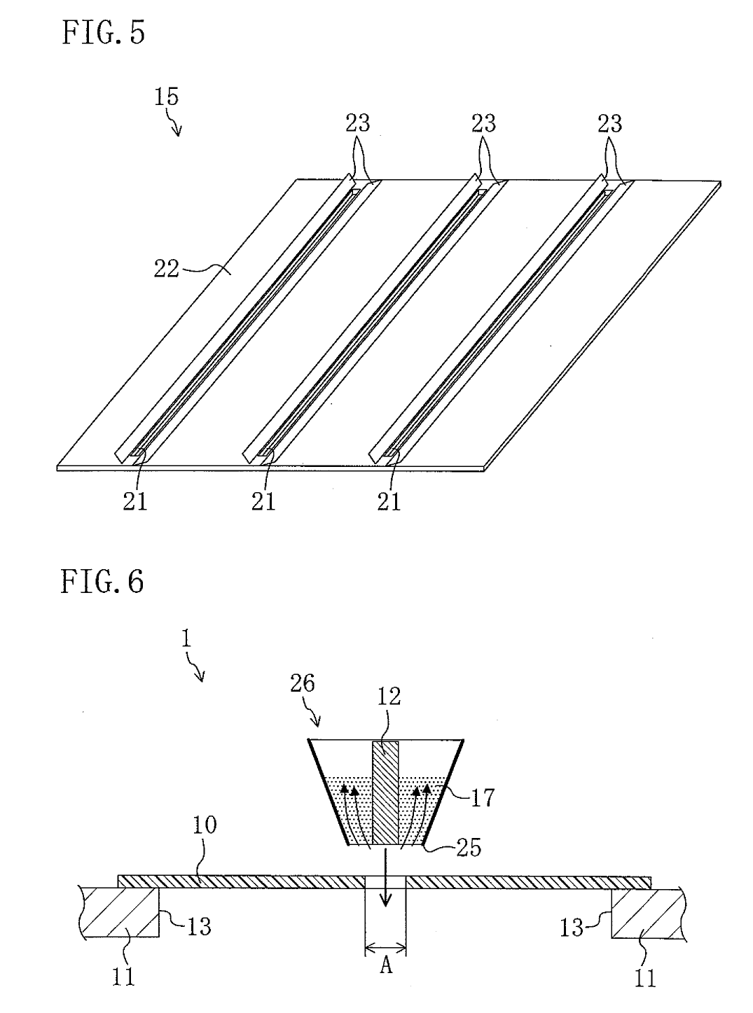

FIGS. 4 and 5 illustrate Preferred Embodiment 2 of the present invention. In the following preferred embodiments, the same components as those shown in FIGS. 1 to 3 are indicated by the same reference numerals to omit the detailed explanation.

FIG. 4 is a cross-sectional view illustrating the structure of a shield member 15 of Preferred Embodiment 2, and FIG. 5 is a perspective view illustrating the appearance of the shield member 15 of Preferred Embodiment 2.

In Preferred Embodiment 1, the shield member 15 is in the shape of a tube and is fixed to the laser emitter 12. In contrast, the shield member 15 of Preferred Embodiment 2 is in the shape of a mask.

Specifically, the shield member 15 includes, as shown in FIGS. 4 and 5, a mask member 22 which is placed on the plastic substrate 10 and has a slit 21 penetrating the mask member 22 and extending in a direction in which the plastic substrate 10 is cut, and shield plates 23 formed on the mask member 22 to extend along the slit 21.

For example, the mask member 22 may be in the shape of a flat plate, and may include a plurality ones of the plate-like slit 21 arranged parallel to each other. A laser emitted from the emitter 12 passes through the slits 21. The mask member 22 is placed with alignment on the plastic substrate 10 on the stage 11, so that the slits 21 correspond to cutting lines on the plastic substrate 10, respectively. Specifically, the plastic substrate 10 is provided with alignment marks (not shown) for the alignment.

The shield member 15 is preferably held in close contact with the surface of the plastic substrate 10.

The shield plates 23 are arranged on both sides of each of the slits 21, and extend in the length direction of the slits 21. Each of the shield plates 23 is fixed at one side thereof to the mask member 22 on the side of the slit 21, and extends obliquely upward in a direction away from the slit 21. In other words, a pair of shield plates 23 on both sides of the slit 21 are arranged in the form of blades having a downward tapered cross section as shown in FIG. 4.

In cutting the plastic substrate 10 using the cutting apparatus 1 of Preferred Embodiment 2, the plastic substrate 10 is placed on the stage 11, and then the shield member 15 is laid on the plastic substrate 10 with alignment. In this manner, the slits 21 of the shield member 15 are laid over the cutting lines on the plastic substrate 10.

Then, the emitter 12 is allowed to make relative movement along the slits 21 of the shield member 15 while emitting the laser. This allows for laser cutting of the plastic substrate 10 along the slits 21.

Also in Preferred Embodiment 2, the shield member 15 is arranged outside the irradiation region A. Therefore, the shield plates 23 of the shield member 15 can block the contaminants 17 generated on the side of the plastic substrate 10 facing the emitter 12. Specifically, the contaminants 17 generated in the irradiation region A can be blocked because they adhere to the inner wall surface of the shield plates 23.

In cutting the plastic substrate 10 into a plurality of panels of the same shape, a single shield member can be used for a plurality ones of the plastic substrate 10. This allows for cost reduction.

### Preferred Embodiment 3

FIG. 6 illustrates Preferred Embodiment 3 of the present invention. FIG. 6 is a cross-sectional view schematically illustrating an exhaust port 25 of an exhaust system 26.

In Preferred Embodiment 1 described above, the cutting apparatus 1 includes the tubular shield member 15. In contrast, in Preferred Embodiment 3, an exhaust system 26 is provided. Specifically, the exhaust system 26 includes a tubular exhaust port 25, so that the contaminants 17 and the air are sucked through the exhaust port 25 and discharged to the outside. The exhaust port 25 is placed on a main body (not shown) of the exhaust system 26 and arranged to face the laser irradiation region A on the plastic substrate 10. The exhaust port 25 is arranged on the side of the plastic substrate 10 facing the emitter 12, and the emitter 12 is fixed to the inside of the exhaust port 25.

In cutting the plastic substrate 10 using the cutting apparatus 1 of Preferred Embodiment 3, in the same manner as in Preferred Embodiment 1, the plastic substrate 10 is placed on the stage 11, and the emitter 12 is allowed to make relative movement together with the exhaust port 25 while emitting the laser. In this process, the contaminants 17 are generated in the laser irradiation region A, but they are discharged outside through the exhaust port 25.

According to Preferred Embodiment 3, the contaminants 17 generated in the irradiation region A can be discharged outside by the exhaust system 26 through the exhaust port 25 before they adhere to the surface of the plastic substrate 10. This structure makes it possible to prevent the contaminants 17 from dispersion, and to prevent the contamination of the plastic substrate 10.

### Preferred Embodiment 4

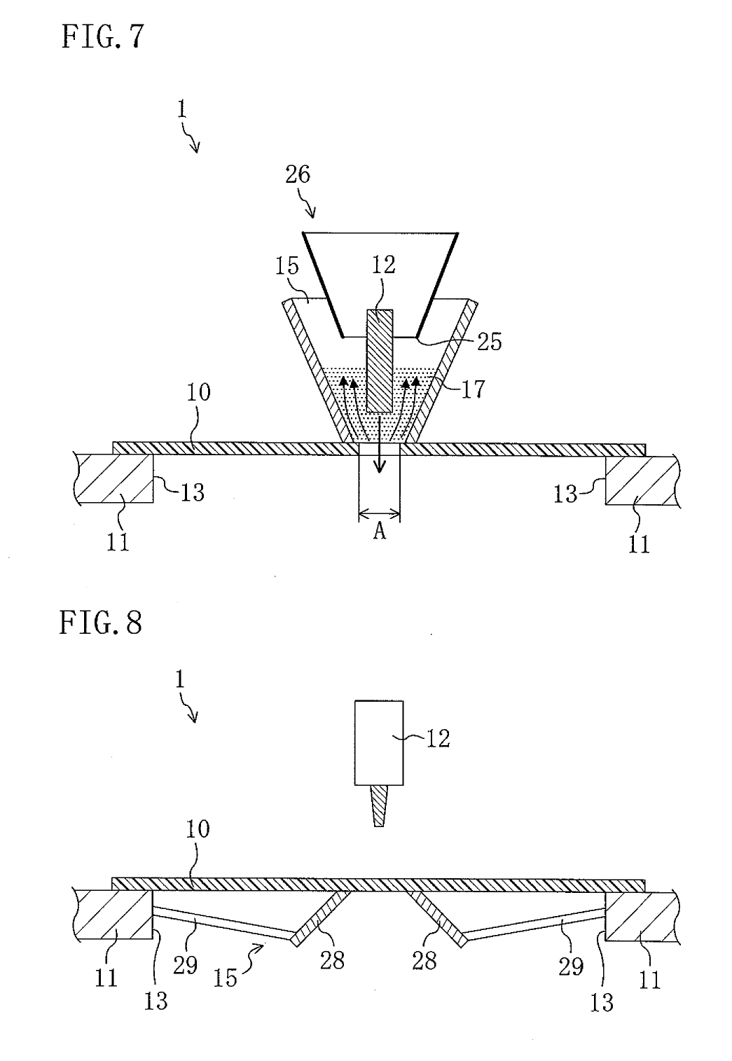

FIG. 7 illustrates Preferred Embodiment 4 of the present invention. FIG. 7 is a cross-sectional view illustrating an exhaust system 26 and a shield member 15.

In Preferred Embodiment 4, the exhaust system 26 of Preferred Embodiment 3 is added to the structure of Preferred Embodiment 1 including the tubular shield member 15.

Specifically, the laser emitter 12 is provided with the shield member 15 and the exhaust port 25. Therefore, the shield member 15 and the exhaust port 25 are allowed to move relative to the plastic substrate 10 together with the emitter 12. The shield member 15 is arranged so that a bottom end thereof is in close contact with the surface of the plastic substrate 10. The exhaust port 25 is arranged so that a bottom end thereof is positioned inside an upper portion of the shield member 15. In other words, the bottom end of the exhaust port 25 is surrounded by the shield member 15.

In cutting the plastic substrate 10 using the cutting apparatus 1 of Preferred Embodiment 4, the emitter 12 is moved relative to the plastic substrate 10 together with the exhaust port 25 and the shield member 15. This allows for the laser cutting of the plastic substrate 10 and the blocking of the contaminants 17 generated on the side of the irradiation region A facing the emitter 12 by adhering them onto the inner wall surface of the shield member 15. In addition, the contaminants 17 that reached to the upper portion of the shield member 15 can be discharged outside by the exhaust system 26 through the exhaust port 25.

Thus, according to Preferred Embodiment 4, the contaminants 17 that reached to the upper portion of the shield member 15 can be discharged outside through the exhaust port 25, and therefore, the dispersion of the contaminants 17 can be prevented with more reliability.

### Preferred Embodiment 5

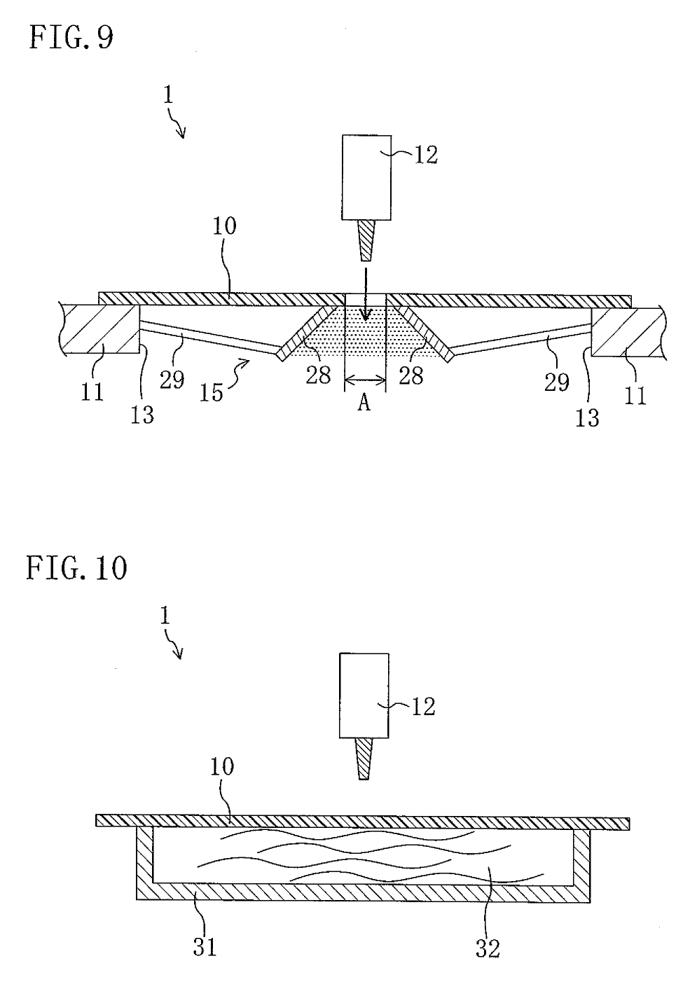

FIGS. 8 and 9 illustrate Preferred Embodiment 5 of the present invention. FIG. 8 is a cross-sectional view schematically illustrating the structure of a shield member 15. FIG. 9 is a cross-sectional view illustrating a plastic substrate 10 being cut.

In Preferred Embodiments 1 and 2, the shield member 15 is arranged on the side of the plastic substrate 10 facing the emitter 12. In contrast, the shield member 15 of Preferred Embodiment 5 is arranged on the side of the plastic substrate 10 opposite the emitter 12.

As shown in FIG. 8, the shield member 15 of Preferred Embodiment 5 includes a pair of shield plates 28 extending along a direction of a cutting line on the plastic substrate 10 (a cutting direction). The pair of shield plates 28 preferably have the shape of blades having an upward tapered cross section. Upper end portions of the shield plates 28 may be adjacent to the plastic substrate 10. The upper end portions may be in close contact with the surface of the plastic substrate 10, or alternatively, they may be in contact with the surface of the plastic substrate 10.

To a lower end portion of each of the shield plates 28, one end of a bracket 29 is connected. The other end of the bracket 29 is connected to the stage 11. This structure allows for the fixing of the shield plates 28 to the stage 11 through the bracket 29.

In cutting the plastic substrate 10 using the cutting apparatus 1 of Preferred Embodiment 5, the emitter 12 which is emitting a laser is moved relative to the plastic substrate 10. This allows for the laser cutting of the plastic substrate 10, and the blocking of the contaminants 17 generated in the irradiation region A opposite the emitter 12 by adhering them onto the inner wall surfaces of the shield plates 28 of the shield member 15, as shown in FIG. 9.

### Preferred Embodiment 6

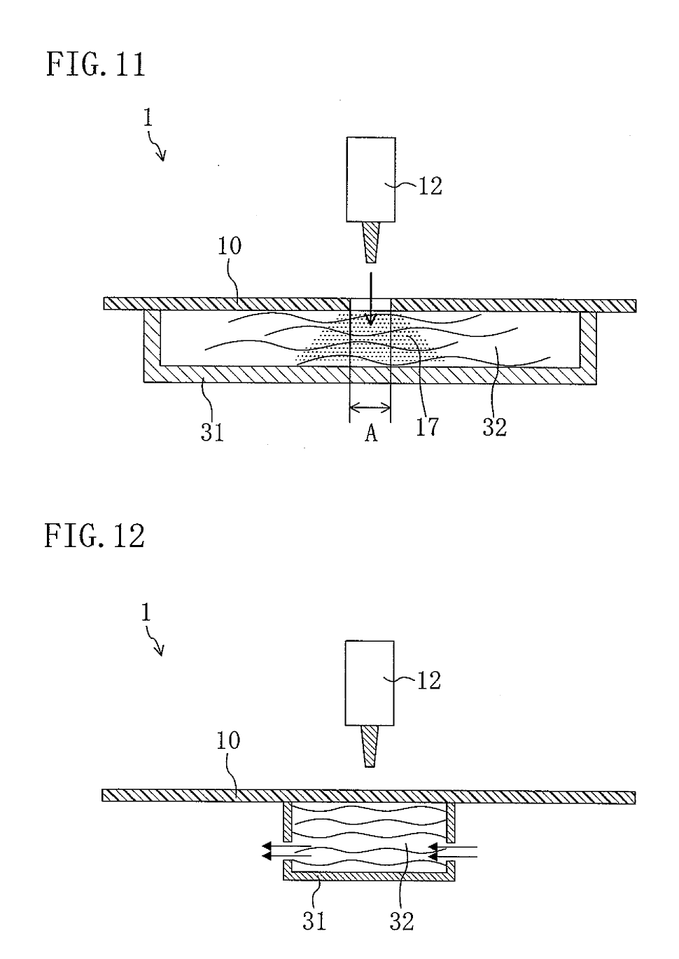

FIGS. 10 to 12 illustrate Preferred Embodiment 6 of the present invention. FIG. 10 is a cross-sectional view illustrating a plastic substrate 10 placed on a storage tank 31. FIG. 11 is a cross-sectional view illustrating the plastic substrate 10 being cut.

The cutting apparatus of Preferred Embodiment 6 includes, as shown in FIG. 10, a storage tank 31 containing liquid 32 so that the liquid 32 is brought into contact with the surface of the plastic substrate 10 opposite the emitter 12. A top end of the storage tank 31 is opened, and water 32 fills the tank. That is, a level of water in the storage tank 31 is equal to the top end of the storage tank 31. When the plastic substrate 10 placed on the storage tank 31, the bottom surface of the plastic substrate 10 (i.e., the surface opposite the emitter 12) is brought into contact with the water 32 in the storage tank 31 due to surface tension of the water 32.

The storage tank 31 may be formed as the stage 11 of Preferred Embodiment 1, or may be formed independently from the stage 11.

In cutting the plastic substrate 10 using the cutting apparatus 1, as shown in FIG. 11, the emitter 12 which is emitting a laser is moved relative to the plastic substrate 10 placed on the storage tank 31. In this manner, the plastic substrate 10 is cut by laser irradiation, with the surface of the plastic substrate 10 opposite the emitter 12 kept in contact with the water 32.

Therefore, in Preferred Embodiment 6, the contaminants 17 generated on the surface of the plastic substrate 10 opposite the emitter 12 are dispersed into the water 32. This structure makes it possible to prevent re-adhesion of the contaminants to the surface of the plastic substrate 10, and to prevent the contamination of the plastic substrate 10.

Further, as schematically shown in a cross-sectional view of FIG. 12, a pump which is not shown may be connected to the storage tank 31 so as to circulate the water 32 in the storage tank 31. This allows the water 32 to flow along the surface of the plastic substrate 10, and therefore, the dispersion of the contaminants into the water 32 is promoted. As a result, the re-adhesion of the contaminants, even if they are large in amount, can be prevented with efficiency.

The liquid contained in the storage tank 31 is not limited to water, and other kinds of liquid may be used as long as they are stable and do not absorb the laser.

### Preferred Embodiment 7

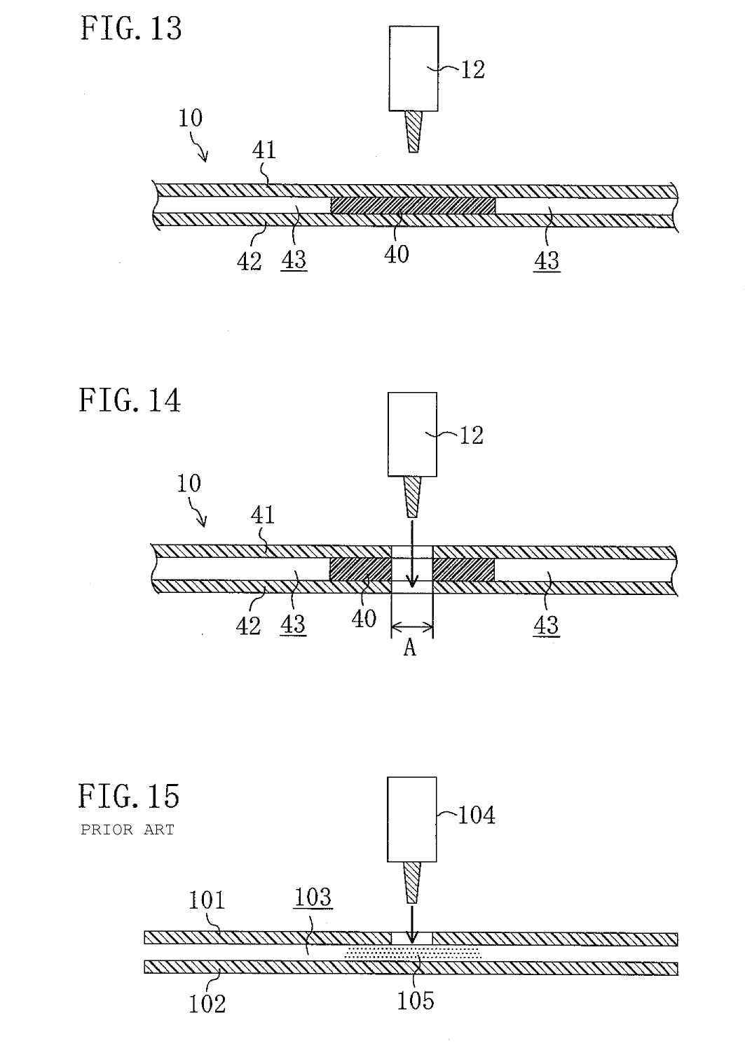

FIGS. 13 and 14 illustrate Preferred Embodiment 7 of the present invention. FIG. 13 is a cross-sectional view schematically illustrating a portion of a plastic substrate 10 which is a bonded substrate. FIG. 14 is a cross-sectional view illustrating the plastic substrate 10 being cut.

The plastic substrate 10 of Preferred Embodiment 7 includes a pair of substrates 41 and 42 bonded together with a sealant 40 made of a resin. The plastic substrate 10 is, for example, a bonded substrate base which is an assembly of a plurality of bonded substrates each constituting a display panel such as a liquid display panel.

Specifically, although FIG. 13 shows only a portion of the bonded substrate base for explanation, the plastic substrate 10 as the bonded substrate base includes a first substrate base 41 and a second substrate base 42 arranged to face the first substrate base 41. A gap of about 5 μm to about 10 μm is formed between the first substrate base 41 and the second substrate base 42, and a plurality of sealants 40 are formed in the gap, each of which is substantially in the shape of a frame when viewed from a direction normal to the substrate. A cell 43 is formed in a region surrounded by the sealant 40, and filled with liquid crystal which is a display medium. Then, the plastic substrate 10 as the bonded substrate base is divided into the cells 43. Thus, the plurality of bonded substrates are formed, from which the liquid display panels are formed.

In Preferred Embodiment 7, as shown in FIG. 14, the plastic substrate 10 which is the bonded substrate base is laser-cut at a region where the sealant 40 is arranged. Though not shown, also in Preferred Embodiment 7, the shield member 15 is fixed to the laser emitter 12 in the same manner as Preferred Embodiment 1.

Therefore, in Preferred Embodiment 7, the same advantages as those described in Preferred Embodiment 1 can be obtained because of the presence of the shield member 15. Further, in the region at which the plastic substrate 10 is cut, the sealant 40 is present in the gap between the first substrate base 41 and the second substrate base 42. Therefore, contaminants generated by the laser cutting can be prevented from entering the gap between the substrate bases 41 and 42. This structure makes it possible to effectively prevent the contamination of the plastic substrate 10.

### Other Preferred Embodiments

Preferred Embodiment 1 is directed to an example in which the shield member 15 is arranged on the side of the plastic substrate 10 facing the emitter 12. In contrast, Preferred Embodiment 5 is directed to an example in which the shield member 15 is arranged on the side of the plastic substrate 10 opposite the emitter 12. However, the present invention is not limited thereto, and the shield member 15 may be arranged on at least one of the side of the plastic substrate 10 facing the emitter 12 and the side of the plastic substrate 10 opposite the emitter 12. This structure makes it possible to prevent the contamination of the plastic substrate 10 by the contaminants on both or one of the sides of the plastic substrate 10.

Preferred Embodiment 2 is directed to an example in which the shield member 15 in the shape of a mask is arranged on the side of the plastic substrate 10 facing the emitter 12. However, the present invention is not limited thereto, and the mask-shaped shield member 15 may be arranged on the side opposite the emitter 12, or the mask-shaped shield member 15 may be arranged on both of the side facing the emitter 12 and the side opposite the emitter 12. The shield member 15 is not limited to the mask shape, and it may be formed of only the shield plates extending in a direction in which the substrate is cut.

Preferred Embodiment 3 is directed to an example in which the exhaust port 25 of the exhaust system 26 is arranged on the side of the plastic substrate 10 facing the emitter 12. However, the present invention is not limited thereto, and the exhaust port 25 may be arranged on at least one of the side of the plastic substrate 10 facing the emitter 12 and the side of the plastic substrate 10 opposite the emitter 12.

Preferred Embodiment 4 is directed to an example in which the shield member 15 and the exhaust port 25 are arranged on the side of the plastic substrate 10 opposite the emitter 12. However, the present invention is not limited thereto. The shield member 15 and the exhaust port 25 may be arranged on the side of the plastic substrate 10 opposite the emitter 12, or they may be arranged on both of the side facing the emitter 12 and the side opposite the emitter 12.

Preferred Embodiment 6 is directed to an example in which the storage tank 31 is arranged on the side of the plastic substrate 10 opposite the emitter 12. In this example, the shield member 15 described in Preferred Embodiments 1 and 2 may additionally be provided. Further, as described in Preferred Embodiment 3, the exhaust port 25 may additionally be arranged on the side of the plastic substrate 10 facing the emitter 12. Moreover, as described in Preferred Embodiment 4, the shield member 15 and the exhaust port 25 may be arranged on the side of the plastic substrate 10 facing the emitter 12. This structure makes it possible to prevent the contamination of the side of the plastic substrate 10 facing the emitter 12.

Preferred Embodiment 7 is directed to an example in which the shield member 15 described in Preferred Embodiment 1 is arranged on the side of the plastic substrate 10 facing the emitter 12 with the sealant 40 provided on the plastic substrate 10. However, the present invention is not limited thereto, and the shield member 15 described in Preferred Embodiments 2 and 5 may be provided. Further, as described in Preferred Embodiments 3 and 4, the exhaust port 25 may be provided. This structure makes it possible to prevent the contamination of the side of the plastic substrate 10 facing the emitter 12 and the side of the plastic substrate opposite the emitter 12.

As described above, the present invention is useful for a method for cutting a plastic substrate and an apparatus for cutting the plastic substrate. In particular, the present invention is suitable for preventing the contamination of the plastic substrate near the laser-cut section thereof, while maintaining an optical characteristic of the plastic substrate.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-16. (canceled)

17. A method for laser-cutting a plastic substrate comprising:
making relative movement of a laser emitter along a surface of the plastic substrate while the laser emitter emits a laser; wherein
a shield member is arranged outside a laser irradiation region on the plastic substrate.

18. The method of claim 17, wherein the shield member is arranged on at least one of a side of the plastic substrate facing the emitter and a side of the plastic substrate opposite the emitter.

19. The method of claim 17, wherein the shield member has a shape of a tube surrounding at least a portion of the emitter.

20. A method for laser-cutting a plastic substrate comprising:
making relative movement of a laser emitter along a surface of the plastic substrate while the laser emits a laser; wherein
an exhaust port of an exhaust system is arranged to face a laser irradiation region on the plastic substrate.

21. The method of claim 20, wherein the exhaust port is arranged on at least one of a side of the plastic substrate facing the emitter and a side of the plastic substrate opposite the emitter.

22. A method for laser-cutting a plastic substrate comprising:
making relative movement of a laser emitter along a surface of the plastic substrate while the laser emitter emits a laser; wherein
irradiation with the laser is performed with a surface of the plastic substrate opposite the emitter being in contact with liquid.

23. The method of claim 22, wherein the liquid flows along the surface of the plastic substrate.

24. The method of claim 17, wherein the plastic substrate includes a pair of substrates bonded together with a sealant, and the plastic substrate is cut at a region where the sealant is arranged.

25. An apparatus for cutting a plastic substrate comprising:
a stage on which the plastic substrate is placed; and
a laser emitter arranged to face the stage and arranged to emit a laser while making relative movement along a surface of the plastic substrate to laser-cut the plastic substrate; wherein
the apparatus includes a shield member arranged outside a laser irradiation region on the plastic substrate.

26. The apparatus of claim 25, wherein the shield member is fixed to the emitter.

27. The apparatus of claim 26, wherein the shield member is in the shape of a tube surrounding at least a portion of the laser emitter.

28. The apparatus of claim 25, wherein the shield member is fixed to the stage on a side of the plastic substrate opposite the emitter.

29. The apparatus of claim 25, wherein the shield member includes a mask member on the plastic substrate and has a slit penetrating the mask member and extending in a direction in which the plastic substrate is cut, and a shield plate arranged on the mask member to extend along the slit.

30. An apparatus for cutting a plastic substrate comprising:
a stage on which the plastic substrate is placed; and
a laser emitter arranged to face the stage and arranged to emit a laser while making relative movement along a surface of the plastic substrate to laser-cut the plastic substrate; wherein
the apparatus includes an exhaust system having an exhaust port arranged to face a laser irradiation region on the plastic substrate.

31. The apparatus of claim 30, wherein the exhaust port is arranged on at least one of a side of the plastic substrate facing the emitter and a side of the plastic substrate opposite the emitter.

32. An apparatus for cutting a plastic substrate comprising:
a stage on which the plastic substrate is placed; and
a laser emitter arranged to face the stage and arranged to emit a laser while making relative movement along a surface of the plastic substrate to laser-cut the plastic substrate; wherein
the apparatus includes a storage tank containing liquid so that the liquid is in contact with a surface of the plastic substrate opposite the emitter.
